(19) United States
(12) Patent Application Publication
(10) Pub. No.: US 2006/0274521 A1
(43) Pub. Date: Dec. 7, 2006

(54) Lighting device for a realty sign

(76) Inventor: Michael E. Ullrich, Chesterfield, MI (US)

Correspondence Address: YOUNG & BASILE, P.C., 3001 WEST BIG BEAVER ROAD, SUITE 624, TROY, MI, 48084, US

(21) Appl. No.: 11/416,716

(22) Filed: May 3, 2006

Related U.S. Application Data
(60) Provisional application No. 60/686,980, filed on Jun. 3, 2005.

(51) Int. Cl. F21L 19/00; F21S 13/10

(52) U.S. Cl. 362/159; 362/431

(57) ABSTRACT

A lighting device is connectable to a horizontal arm of a realty sign post for directing light to both sides of the sign. The device includes a mounting structure and an upper housing. The device is actuated by a polar rechargeable batter disposed in the housing. Solar panels are connected to an arcuate surface of the upper housing of the device and electrically connected to the batter and a series of LED lights fitted along a pair of cavities in the mounting structure. The lighting device is attached to the realty sign post by pivotal arms that selectively secure around the horizontal arm.

This application claims priority of Provisional Patent Application Ser. No. 60/686,980 filed on Jun. 3, 2005.

### BACKGROUND

The present invention relates to a lighting device, and more particularly to a lighting device for a realty sign

Realty signs are important marketing tools for selling real estate property. The realty signs are generally placed in a strategic location in front of the real estate property so that it can be seen by potential customers when driving or walking down the street. However, once darkness falls, the information on the realty sign is not visible except by head lights of oncoming cars. Potential customers may bypass a realty sign of available property at night without realizing it.

Attempts have been made to light the realty signs. However, access to electrical power was usually required. Because portability and visibility of realty signs is an important aspect in the real estate business, confining a realty sign near an electrical outlet can be inconvenient or impossible. The realty sign must be placed where it is easily visible from the street and not confined by electrical outlets.

Therefore it is desirable to provide a device that is portable and that illuminates both sides of the realty sign without the necessity of positioning the realty sign adjacent to an electrical outlet.

### SUMMARY OF THE INVENTION

A lighting device for a realty sign is provided having a mounting structure mountable to a horizontal member of a realty post. The mounting structure has a bridge formation defining a cavity therein extending the axial length of the mounting structure. The cavity is sized for receiving the horizontal member of the realty post. A solar rechargeable battery is positioned on an upper surface of the bridge formation of the mounting structure. Adjacent the bridge formation are a pair of laterally extending shelves. A light is positioned under each shelf directed toward the realty sign hanging from the horizontal member. The lighting device further includes an arcuate upper housing positioned on the mounting structure for covering the solar rechargeable battery. The upper housing has a solar panel secured to the upper surface of the arcuate upper housing. The solar panel is electrically connected to the rechargeable battery.

In another aspect the lighting device includes pivotal arms connected to a lower surface of one of the shelves for connecting the lighting device onto the horizontal member of the realty post. A locking mechanism may be provided to lock the pivotal arms in a connecting position.

Another aspect of the lighting device includes a cutout formed in the arcuate upper housing having a removable tube positioned in the cutout for storing printed information.

### BRIEF DESCRIPTION OF THE DRAWINGS

FIG. 1 is a perspective view of a lighting device for a realty sign;

FIG. 2 is an exploded perspective view of the lighting device including a mounting structure and an upper housing as shown in FIG. 1;

FIG. 3 is a perspective view of the bottom of the lighting device illustrating certain features.

FIG. 4 is a perspective view of a portion of the bottom of the lighting device illustrating a pivotal arm in a locked position;

FIG. 5 is a plan view of the bottom of the mounting structure;

FIG. 6 is a sectional view of the mounting structure taken along lines 6-6 in FIG. 5;

FIG. 7 is a top plan view of the upper housing;

FIG. 8 is a sectional view of the upper housing taken along lines 8-8 in FIG. 7; and

FIG. 9 is a perspective view of another aspect of a front area of the light device.

### DETAILED DESCRIPTION

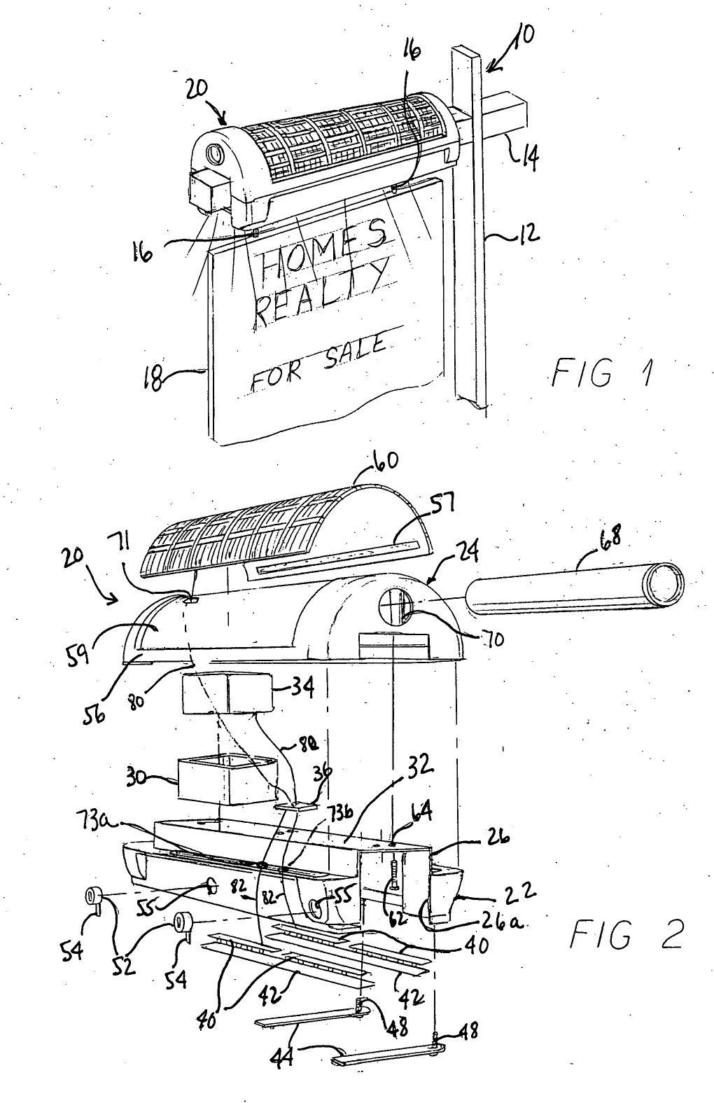

Referring to FIGS. 1-8, the lighting device 10 according to one aspect is intended for retro-fitting onto an existing realty sign post 10 having a vertical member 12 staked into the ground and a horizontal member 14 positioned parallel and spaced above the ground. The horizontal member 14 will normally have hooks 16 extending from a lower portion of the horizontal member 14 for hanging the realtv sign 18.

The lighting device 20 includes a lower mounting structure 22 and an upper housing 24. The mounting structure 22 has an elongate cavity 26a formed by a three sided square bridge 26. The cavity 26a is sized and configured for receiving the horizontal member 14 of the realty post 10. Laterally extending from each side of the bridge 26 defining the cavity 26a are shelves 28a, 28b that extend the axial length of the mounting structure 22. The shelves 28a and 28b provide surfaces for mounting the upper housing 24 onto the mounting structure 22.

A rectangular housing 30 is provided and mounted on the upper surface 32 of the bridge 26 defining the cavity 26. As an alternative, the housing 30 may be integrally molded as one piece to the upper surface 32 of the bridge. The rectangular housing 30 is sized for receiving a small rechargeable battery 34. A circuit board 36 can be positioned adjacent to the rectangular housing 30. Typical batteries would be 12 volts, 4.5 or 7.5 amps, measuring 3″×3″×4″ or 3″×5″×2.5″ respectively.

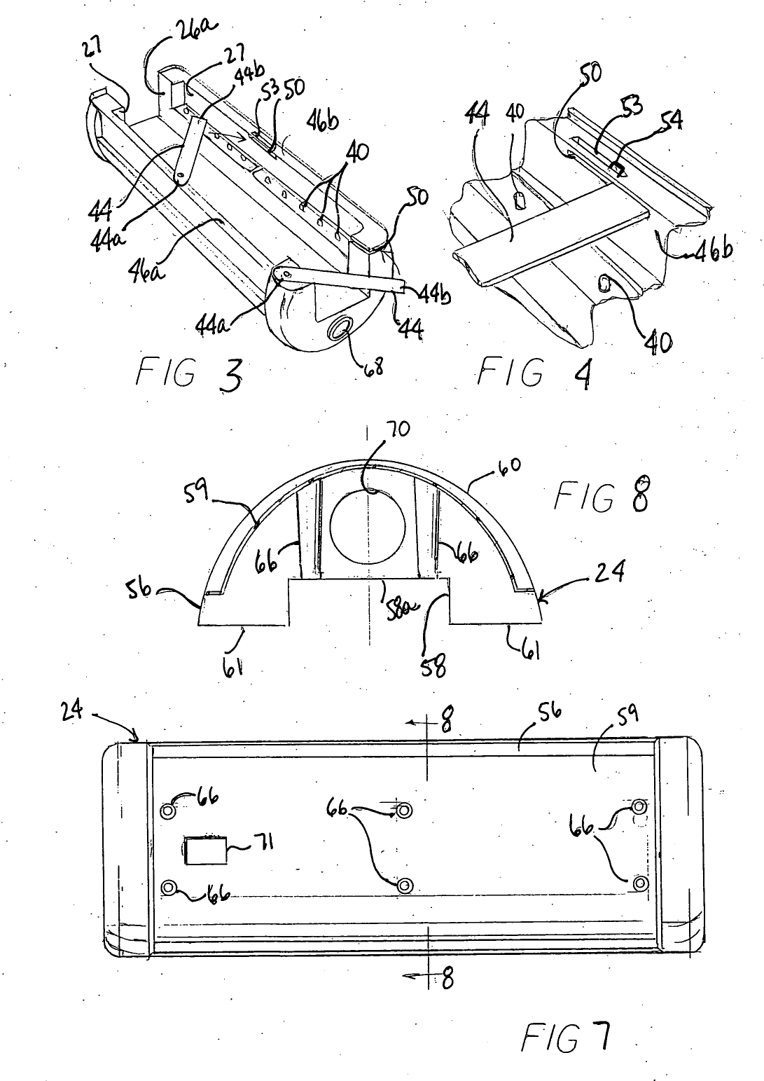

FIG. 3 shows a bottom view of the lighting device 10 showing certain features of the lower mounting structure 22. Adjacent the cavity 26a for the horizontal member 14, a channel 27 is formed under each shelf for placement of LED lights 40. The LED lights 40 may be connected in the channel 27 of the mounting structure 22 by screws or double-sided tape (not shown). The lights 40 extend along the axial length of the shelves 28a and 28b. Lights 40 are positioned for illuminating both sides of the realty sign 18. The circuit board 36 can be configured to activate the lights at predetermined intervals and for predetermined lengths of time. The lights 40 are protected by a lens 42 that is placed over the lights along the entire axial length. The lens is secured in place by double-sided tape. (not shown).

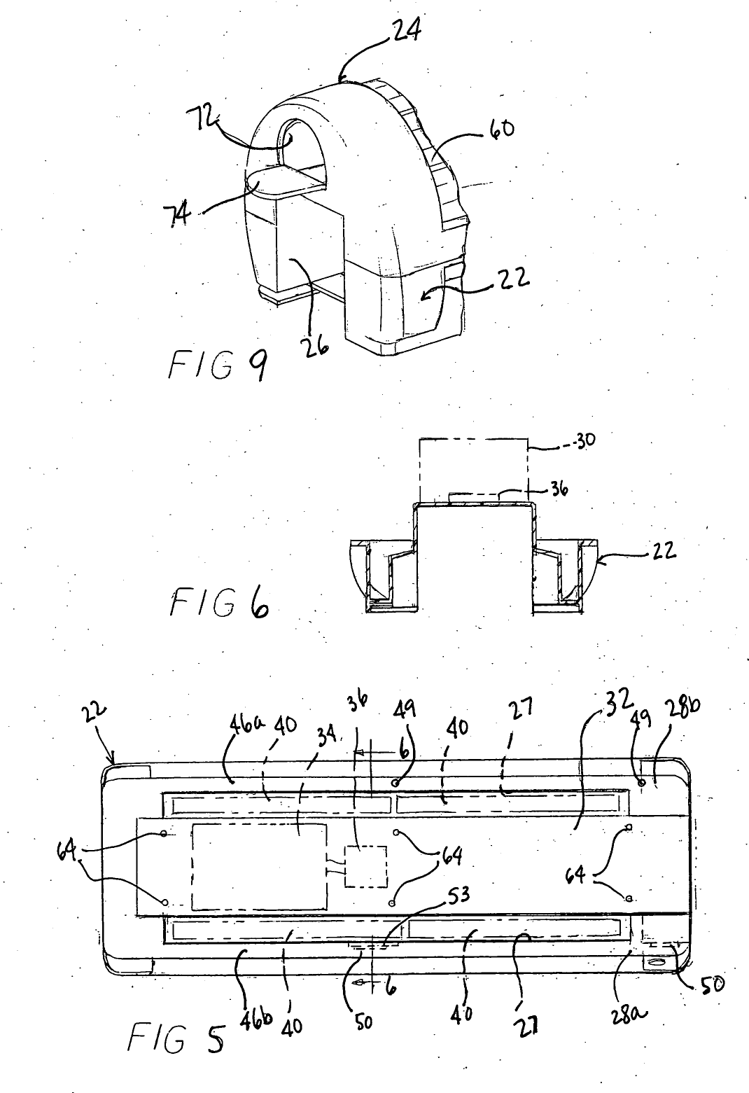

The lighting device 20 is secured to the realty sign post 10 by pivotal arms 44. The pivotal arms 44 have one end 44a secured to a bottom rail surface 46a by a spring loaded nut and bolt set 48 through aperture 49 (FIG. 5). Each of the arms 44 pivot about its respective aperture 49. To secure the lighting device 10 onto the horizontal member 14, the pivotal arms 44 span underneath the horizontal member 14 and into grooves 50 disposed in rail 46b. A lock mechanism 52 may be provided through side apertures 55 of the mounting structure 22. The lock mechanism 52 includes rotatable locking tabs 54 that can be rotated in position into a slot 53 as shown in FIG. 4 to lock the pivotal arms 44 within the groove 50 to prevent unwanted removable of the lighting device 20 from the realty post 10 by vandals.

The lighting device also includes an upper housing 24 having an upper arcuate surface 56 and a lower surface 58 that complements the upper surface of the mounting structure 22. The lower surface 58 of the housing 24 includes a cut out 58a at both ends for receiving a portion of the bridge 26 therein. Over 75% of the arcuate surface 56 is slightly recessed for receiving a solar panel 60 thereon. The solar panel 60 has an arcuate configuration for placement in the recess area 59 of the upper surface 56 in the upper housing 24 so that when the solar panel 60 is in place the solar panel 60 is flush and at the same arcuate level as the remainder of the upper surface 56. The solar panel is secured in the recess area 59 with double-sided tape 57. One manufacturer of double-sided tape 57 is the 3M Corporation, having its corporate headquarters in Minnesota.

The upper housing 24 has an essentially hollow interior for enclosing the circuit board 36 and battery 34 and its housing 30. The upper housing 24 protects the battery 34 and the circuitry from the outside elements. The upper housing 24 has bottom legs 61 that are disposed on the shelves 46a, 46b when assemble to the mounting structure 22. The upper housing 24 is connected to the mounting structure 22 through bolts 62 that extend through apertures 64 in the mounting structure 22 into bosses 66 in the upper housing 24.

As can be seen in FIGS. 2 and 8, the upper housing 24 has a cylindrical member 68 disposed in an aperture 70 for storing pertinent information regarding the real estate property for sale. The cylindrical member or tube 68 may be removable from the upper housing of 24. Alternatively, the tube 68 may be secured within the upper housing 24. As another alternative as shown in FIG. 9, the compartment 72 may be any shape and further include a door 74 for holding and storing pertinent information regarding the real estate.

As shown in FIG. 2 electrical leads 80 extend from the circuit board 36 to the battery 34 and solar panel 60. Electrical leads 82 also extend from the circuit board 36 to the LED lights 40. The electrical leads 80 are threaded from the solar panel 60 through aperture 71 in the upper surface 56 in the upper housing 24 to the battery 34. The electrical leads 82 are threaded from the circuit board 36 through apertures 73a, 73b in the shelves 48a, 48b to the respective lights 40.

The upper housing 24 and mounting structure 22 can be made of a high density polyethylene. The lighting device 20 is easily assembled by first connecting the upper member 24 to the mounting structure 22 and securing the two components together with bolts 62 through apertures 63 and bosses 66. Although not shown, the lateral edges of the upper housing 24 and mounting structure 22 from a tongue and groove connection to add strength to the lighting device 20 and to prevent warpage from climatic heat and cold. The lighting assembly 20 is distributed and sold as a one piece unit. The lighting assembly 20 can be easily assembled by the realtor onto an existing realty sign 10. The lighting device 20 is positioned on the horizontal member 14 of the realty sign so that the bridge 26 is resting on the upper surface of the horizontal member 14, wherein the horizontal member 14 is disposed in cavity 26a. The pivotal arms 44 are pivoted under the horizontal member 14 so that the free ends 44b slide into grooves 50. The pivotal arms 44 can be locked within the grooves 50 with a key (not shown) into the lock mechanism 52 to pivot the locking tabs 54 into slot 53.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A lighting device for a realty sign
a mounting structure mountable to a horizontal member of a realty post, said mounting structure having a bridge formation defining a cavity extending the axial length of the mounting structure, said cavity sized for receiving the horizontal member of the realty
a pair of laterally extending shelves adjacent each side of the bridge formation;
a solar rechargeable battery positioned on an upper surface of the bridge formation;
an arcuate upper housing positioned on the mounting structure for covering the solar rechargeable battery, said upper housing having a pair of legs configured for setting on the pair of laterally extending shelves;
a solar panel mounted to the arcuate upper housing and electrically connected to the battery;
a light positioned under each shelf of the mounting structure; and
means for activating each light.

2. The lighting device of claim I further comprising a pivoting arm connected to a lower surface of one of the shelves.

3. The lighting device of claim 1, wherein the arcuate upper housing has a cut out at both ends for receiving the bridge formation of the mounting structure, and a tube positioned above one of the cut outs, wherein the tube is stored within the upper housing.

4. The lighting device of claim 1, wherein the solar panel has an arcuate formation for covering at least 75% of the arcuate upper housing.

5. The lighting device of claim 4, wherein the arcuate upper housing has an aperture therethrough and the solar panel has electrical leads extending from the solar panel, through the apertures to the rechargeable battery.

6. The lighting device of claim 2, further comprising a lock mechanism for locking the pivoting arm to the lower surface of one of the shelves.

7. The lighting device of claim 1, further comprising an opening in the upper housing for receiving and storing printed information.

8. The lighting device of claim 1, wherein the solar panel has an arcuate formation for covering three sides of the arcuate upper housing.

9. The lighting device of claim 1, wherein the mounting structure has a pair of elongate cavities extending the axial length of each laterally extending shelves and a strip of LED lights secured in each of the elongate cavities.

10. A lighting device for lighting a realty sign on a post having a horizontal member, the lighting device comprising:
a mounting structure mountable to a horizontal member of the post, said mounting structure having a pair of longitudinal edges for positioning on each side of the horizontal member;
a strip of LED lights mounted on a lower surface of the mounting structure, wherein a strip of LED lights is mounted adjacent to each longitudinal edge of the mounting structure;
an upper housing and a battery stored therein, said upper housing connectible to the mounting structure; and
a solar panel mounted on an upper surface of the upper housing, said solar panel electrically communicating with the battery;

11. The lighting device of claim 10, further including means for locking the lighting device onto the horizontal member.

12. The lighting device of claim 10, further including means in the upper housing for storing printed information.
